(19) United States
(12) Patent Application Publication
(10) Pub. No.: US 2026/0025356 A1
(43) Pub. Date: Jan. 22, 2026

(54) SYSTEMS AND METHODS FOR IDENTIFYING DNS RESOLVERS

(71) Applicant: Open Text Inc., Menlo Park, CA (US)

(72) Inventors: Jonathan Barnett, Lafayette, CO (US); Levina Lioe, Broomfield, CO (US); Michael Balloni, San Diego, CA (US); Michael Harvey, Broomfield, CO (US)

(21) Appl. No.: 18/807,594

(22) Filed: Aug. 16, 2024

Related U.S. Application Data
(60) Provisional application No. 63/672,189, filed on Jul. 16, 2024.

(51) Int. Cl. H04L 61/4511; H04L 9/40; H04L 61/58

(52) U.S. Cl. CPC H04L 61/4511; H04L 61/58; H04L 63/0236

(57) ABSTRACT

Embodiments provide systems and methods for identifying domain name service (DNS) resolvers. A computer-implemented method includes detecting a request from a client device to a destination. The method further includes sending a DNS request from the client device to the destination, receiving, at the client device, a DNS response from the destination, identifying the destination as a DNS resolver based on receiving the DNS response, and based on identifying the destination as a DNS resolver, blocking, at the client device, connections to the destination.

### RELATED APPLICATIONS

This application claims the benefit of priority under 35 U.S.C. § 119(e) to U.S. Provisional Application No. 63/672,189, entitled “Systems and Methods for Identifying DNS Resolvers,” filed Jul. 16, 2024, which is hereby fully incorporated by reference herein.

### TECHNICAL FIELD

This disclosure relates generally to network data security. More specifically, this disclosure relates to access to network locations. Even more specifically, embodiments relate to identifying previously unidentified domain name service resolvers.

### BACKGROUND

The process of Domain Name System (DNS) resolution involves converting a domain name into an IP address. Each domain or subdomain has one or more authoritative DNS servers that publish information about that domain and the name servers of any domains “beneath” it. DNS resolution takes place transparently by the operating system for applications such as web-browsers, mail-clients, or other Internet applications. When an application makes a request which requires a DNS lookup, a request is made by the operating system and the operating system then generates a DNS resolution request to a local and/or external DNS server.

One problem with conventional DNS pertains to visibility. For example, while this visibility allows administrators of a network to see DNS requests that users and devices are making, providing the ability to both track users and see what devices or applications are refencing, the corresponding downside of this visibility is that these requests can be transparently redirected or exploited by altering DNS responses, allowing for data exfiltration and exposure to viruses and other malware.

Another problem with conventional DNS pertains to privacy. For example, the use of DNS may expose users or requestors on the network. These exposed requestors might be applications the user uses, internet connected devices, etc. DNS may also expose what websites or domains a user is visiting, etc. As almost everything on the network and internet uses DNS, these DNS requests may expose how users use the network and internet.

Yet another problem with conventional DNS pertains to security. For example, the use of DNS may expose users or requestors to malicious or harmful domains on the internet by providing the corresponding address. These exposed requestors might be applications the user uses, internet connected devices, etc.

Due to these concerns with Domain Name System (DNS) resolution, new DNS protocols, including DNS over HTTPS (DoH), which is an encrypted DNS protocol, can provide secure ways to derive DNS resolution. It may be desirable to limit computer systems to using trusted DNS resolvers by only allowing DNS requests to specific resolvers. However, the vast and changing nature of the Internet makes it impossible to know all of the available DNS resolvers. Standard DNS requests to unauthorized resolvers can be blocked on TCP/UDP port 53, which is the standard port for DNS. DoH, however, uses port 443, which is a standard port for HTTPS, thus it cannot simply be blocked as it also carries non-DNS traffic. Because DoH requests are encrypted, monitoring software and the like generally have no insight into which HTTPS packets contain DNS requests aside from the destination address for the request, which is still visible.

### SUMMARY

Embodiments for identifying DNS resolvers are disclosed. By identifying previously unknown DNS resolvers, a system can block requests to the DNS resolvers. This can be achieved, in some embodiments, without blocking connections to the port used by the DNS protocol.

One aspect of the present disclosure includes a computer-implemented method for identifying whether domain names or IP addresses are Domain Name System (DNS) resolvers. The method may include detecting, at a client device, a request from an application to a destination, then probing the destination, identifying the destination as a DNS resolver based on result of the probing, and based on identifying the destination as a DNS resolver, blocking, at the client device, any connection request to the destination. Some embodiments include blocking subsequent communication to the identified DNS resolver.

The computer-implemented method further comprises, in some embodiments, identifying an Internet address for the DNS resolver. The computer-implemented method further comprises, in some embodiments, determining a domain associated with the Internet address.

Probing the destination may include sending a DNS request from the client device to the Internet address and receiving at the client device a DNS response from the destination, where the destination is identified as the DNS resolver based on receiving the DNS response from the destination.

Probing the destination may comprise sending a DNS request from the client to the domain associated with the Internet address and receiving at the client device a DNS response from the domain, where the destination is identified as the DNS resolver based on receiving the DNS response from the domain.

The computer-implemented method further comprises, in some embodiments, maintaining, at the client device, a list of unauthorized destinations that comprises, for example, addresses of known DNS resolvers. Embodiments can include blocking requests from the client device to the unauthorized destinations specified in the list of unauthorized destinations, but not blocking requests to destinations not in the list of unauthorized destinations. Thus, for example, a request to a previously unknown DNS resolver is not blocked based on the list of unauthorized destinations. Newly identified DNS resolvers may be added to the list of unauthorized destinations.

The computer-implemented method further comprises, in some embodiments, distributing an identifier for the DNS resolver to a DNS Protection server for further analysis or to other client devices to enable the other client devices to block requests to the DNS resolver.

Embodiments further include systems and computer program products.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts one embodiment of an architecture including an embodiment of a DNS resolver identification.

FIG. 2 depicts a flowchart illustrating an example of a process for DNS resolution.

FIG. 3 depicts a flowchart illustrating an example of a process for identifying requests to DNS resolvers.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

It may be useful to begin with some context that may be helpful for an understanding of embodiments. Humans access information online through domain names, like nytimes.com or espn.com. Web browsers or other applications interact through Internet Protocol (IP) addresses. DNS translates domain names to IP addresses so browsers or other applications can load Internet resources.

Each device connected to the Internet has a unique IP address which other machines use to find the device. DNS eliminates the need for humans to memorize IP addresses such as 192.168.1.1 (in IPv4), or more complex newer alphanumeric IP addresses such as 2400:cb00:2048:1::c629:d7a2 (in IPv6). An IP address is given to each device on the Internet, and that address is necessary to find the appropriate Internet device—like a street address is used to find a particular home. When a user wants to load a webpage, a translation must occur between what a user types into their web browser (desiredsite.com) and the machine-friendly address necessary to locate the desiredsite.com webpage.

Thus, the process of DNS resolution involves converting a domain name (such as www.desiredsite.com) into a computer-friendly Internet address (such as the IP address 123.123.123.123). DNS comprises a hierarchical set of DNS servers. Each domain or subdomain has one or more authoritative DNS servers that publish information about that domain and the name servers of any domains “beneath” it. The hierarchy of authoritative DNS servers matches the hierarchy of domains. At the top of the hierarchy stand the root nameservers: the servers to query when looking up (resolving) a top-level domain name (TLD).

DNS-resolution takes place transparently in applications such as web-browsers, mail-clients or other Internet applications. When an application makes a request which requires a DNS lookup, such applications make a DNS request of the operating system, which sends a DNS resolution request to the configured DNS resolver, which in turn handles the communications required.

Due to the security and privacy risks posed by DNS, it may be desirable to limit DNS resolution to DNS resolvers that are controlled by trusted entities. To this end, an agent (referred to herein as a DNS Protection agent) may be deployed on a computer system to handle DNS resolution. When an application makes a request for a resource that requires DNS resolution, the request is intercepted by the DNS Protection agent and the DNS Protection agent handles resolution for the client device using a trusted DNS Protection server.

When the DNS Protection agent is enabled, it may block all outbound requests to ports commonly associated with communications between DNS clients and servers, such as port 53. Secure DNS protocols, however, may use ports that handle other important traffic such that it is undesirable and impractical to block connections to these ports. Because secure protocol requests are encrypted, the DNS Protection agent may have no insight into whether a request to a destination is a DNS request or some other type of request. To prevent DNS requests to such ports, the DNS Protection agent may be associated with a database of unauthorized destinations that includes known DNS resolvers and may block requests to these DNS resolvers. However, the database of unauthorized destinations may not prevent requests to previously unknown secure DNS resolvers.

The DNS Protection agent, however, can identify previously unknown DNS resolvers and prevent the client device from accessing the previously unknown DNS resolvers. The DNS Protection agent may monitor outbound communications at the client device and intercept packets based on the monitoring. The DNS Protection agent may probe the destination of outbound communication to determine if the destination is a DNS resolver. More particularly, the DNS Protection agent sends a DNS request to the destination—for example, a DoH request in some embodiments. If the destination responds with a DNS response, the DNS Protection agent identifies the destination as a DNS resolver. Thus, communications to the newly identified DNS resolver can be blocked.

As discussed, the DNS Protection agent, in some embodiments, has a list of unauthorized destinations, such as a database of known DNS resolvers. If the destination for a request is in the list of unauthorized destinations, the DNS Protection agent blocks the request without probing the destination. In one embodiment, the DNS Protection agent identifies the IP address of the destination for a request by extracting the destination IP address from a connection—and determines if the destination is an authorized destination by checking the IP address against IP addresses from the list of unauthorized destinations.

The DNS Protection agent may be associated with a cache of IP addresses resolved by a trusted DNS resolver. The DNS Protection agent may perform a reverse DNS lookup of the destination IP address of the DNS request to determine a destination domain. The DNS Protection agent, according to one embodiment, probes the destination by sending a DNS request, such as a DoH request, to the destination. If the destination responds with a DNS response, the DNS Protection agent identifies the destination as a DNS resolver. The DNS Protection agent may block the request to the newly identified DNS resolver. The DNS Protection agent may add the IP address, domain, or other identifying information for the destination to the list of unauthorized destinations to block subsequent requests to the newly identified DNS resolver.

In some embodiments, the DNS Protection agent probes the destination by sending a secure DNS request, such as a DoH request, to the raw destination IP address, without referencing a domain. This might occur, for example, if the destination IP address is referenced directly and not through a domain name. If the destination responds with a DNS response, the DNS Protection agent identifies the destination as a DNS resolver. The DNS Protection agent may block the request to the newly identified DNS resolver. The DNS Protection agent may add the IP address, domain, or other identifying information for the destination to the list of unauthorized destinations to block subsequent requests to the newly identified DNS resolver.

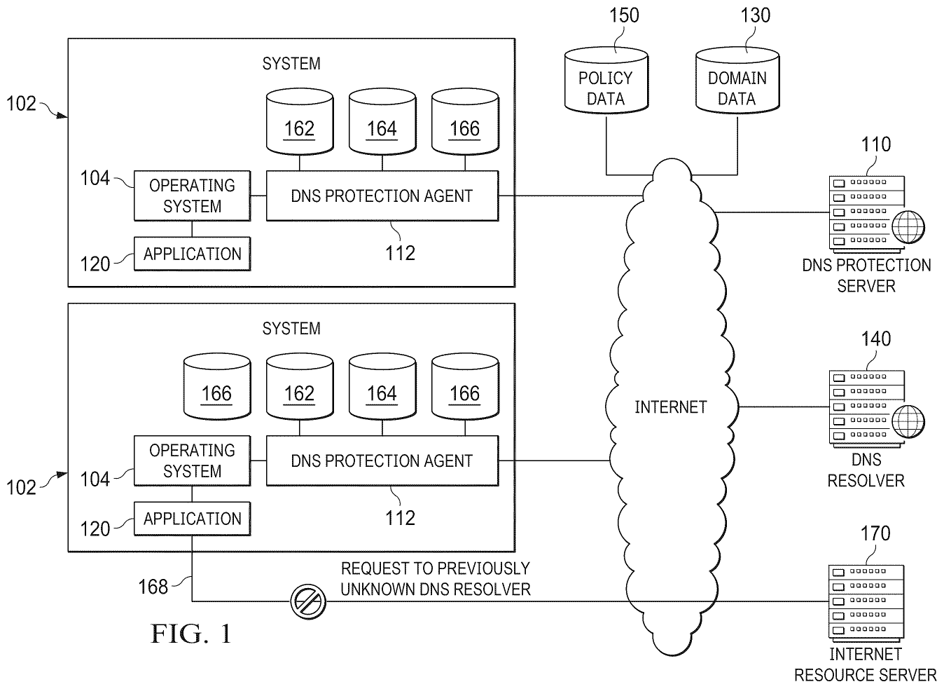

Turning then to FIG. 1, one embodiment of an architecture for a distributed computing network including one embodiment of a DNS Protection system including a DNS Protection agent 112 and DNS Protection servers 110 is depicted. Specifically, one or more DNS Protection servers 110 may serve as a DNS resolver for a set of systems (e.g., client systems 102 in a distributed computing network). These systems may, for example, be a group of computing systems (also referred to as devices or client devices), such as systems within an enterprise, a home network, a Local Area Network (LAN), a Wide Area Network (WAN), etc., for which it is desired to provide DNS protection. Each system 102 comprises a processor and a computer memory in electronic communication with the processor. The computer memory may store instructions for an operating system 104, various applications (e.g., application 120), and a DNS Protection agent 112.

Each system 102 uses the operating system 104 for DNS resolution which is configured to redirect DNS requests to a DNS Protection agent 112. Thus, it may be the case that applications or processes 120 on the system 102 may make requests directly to a DNS resolver 140. Specifically, DNS requests may be sent directly from an application or process 120 to DNS resolver 140, or may be sent from the operating system 104 to the DNS resolver 140.

In many cases, when a process or an application 120, such as a web browser or the like, makes a DNS request (e.g., if the desired DNS record is not in a cache of the application 120), this DNS request is routed to the operating system 104 on the system 102, which will check its cache to determine if the DNS request can be satisfied from cache. If the DNS request from the application 120 cannot be satisfied from cache, the DNS request is routed to DNS resolver 140. The address of the DNS resolver 140 to which the request is routed is configured in the operating system 104 such that the DNS service is aware of the address of the DNS resolver 140. This request is typically sent to UDP or TCP Port 53.

In some instances, DNS requests may be sent directly from an application 120 to DNS resolver 140. For example, certain web browsers are now configured to establish direct connections to configured DNS resolvers (e.g., such as Cloudflare™ or Google DNS resolvers) and make DNS requests directly to these DNS resolvers 140. These requests may also be sent to TCP or UDP Port 53. However, as discussed above, for a variety of reasons, including those concerning security or privacy, it may be less than desirable to utilize DNS resolver 140 that is out of the control of entities providing system 102 or other trusted entities.

Accordingly, it may be desirable that DNS resolution for all applications 120 on the systems 102 be handled through DNS Protection agent 112 and be resolved (or otherwise handled) using DNS Protection servers 110. Thus, DNS Protection agent 112 may be installed on each system 102. DNS Protection agent 112 may configure and interact with the associated system 102 (or applications 120 thereon) such that DNS resolution for the applications or processes 120 of the system is handled through the DNS Protection agent 112 and DNS Leak Protection is implemented such that no DNS requests may be sent from system 102 except by the DNS Protection agent 112.

Thus, when DNS Protection agent 112 is installed on system 102, DNS Protection agent 112 may configure the operating system to redirect DNS requests to the DNS Protection agent 112 (e.g. the DNS Protection agent would set the DNS server address on the operating system to be a loopback address (e.g., 127.0.0.1) and would be configured to receive DNS requests from the operating system 104 and, through this configuration, manage DNS requests from the operating system 104).

As such, when the DNS Protection agent 112 is enabled, it may block all outbound requests to port 53 (e.g., using a firewall software or driver). In this manner, when application 120 attempts to directly send a DNS request to a DNS resolver 140, it may be blocked from doing so. DNS Protection agent 112 may thus provide DNS Leak Protection to block requests to DNS resolver 140.

When a DNS request is received by the DNS Protection agent 112 then (e.g., a DNS request sent by the operating system 104 to the loopback address), DNS Protection agent 112 may resolve the DNS request. DNS Protection agent 112 can maintain a DNS cache 162 of addresses resolved by a trusted DNS source, such as DNS Protection servers 110. DNS cache 162 may be implemented in volatile memory, persistent memory, or a combination thereof. For example, DNS Protection agent 112 or other components of a system 102 may cache responses returned by the DNS Protection servers 110 in the DNS cache 162. In some embodiments, records stored in DNS cache 162 are cached for a set amount of time. Thus, in some cases, DNS Protection agent 112 can resolve the DNS request from DNS cache 162. If the relevant record is not in DNS cache 162, the DNS Protection agent 112 may send the DNS request to DNS Protection servers 110. The DNS Protection agent 112 may, for example, communicate with DNS Protection servers 110 over a secure DNS protocol such as DNS over HTTPS (DoH) or DNS over TLS (DoT).

DNS Protection servers 110 may receive the DNS request from the DNS Protection agent 112 and decide as to how to handle the DNS request. In some embodiments, domain data 130 and system policy data 150 may be utilized to determine a response to a received DNS request. The polices of system policy data 150 may be provided by an administrator, or otherwise determined, and may specify, for example, security policies regarding what types of domains or web sites a system or user may access. Such policies may, for example, specify certain classifications or reputation scores (e.g., as identified in domain data 130) for domains which a system 102 or user may (or may not) access.

The determination whether a domain is blocked may be made with reference to domain data 130 looked up by DNS Protection servers 110. In one embodiment, for example, this domain data may include data on the domain, Universal Resource Locators (URLs), contextual machine learning data on the domain or other data. Such data, for example, may be data from BrightCloud® web classification or web reputation services and may be regularly obtained or updated. Thus, the domain requested or other aspects of the DNS request received at DNS Protection servers 110 may be evaluated against the domain data 130 to determine if a DNS request is to be responded to with the requested domain or a denial returned (e.g., the address of a blocked page or another block or error indication) returned.

For example, a received DNS request may be identified with the particular system 102 where the request originated. A policy associated with the identified systems 102 may be looked up in system policy data 150. The identified policy for the system 102 where the requests originated can then be evaluated for the received DNS request (e.g., using domain data 130 associated with the domain requested). Based on the evaluation of the identified policy for the system 102 or user, a determination can be made whether the received DNS request is to be responded to with the requested domain or a block page (e.g., the address of a blocked page notification or another block or error indication).

If the domain associated with the DNS request is blocked, the DNS Protection servers 110 may return the address of a DNS Protection web server to display a block notification. The response returned by the DNS Protection servers 110 to the DNS Protection agent 112 may then be returned to the requesting application 120 (e.g., through the operating system 104 on the system 102). Thus, if the requested domain was blocked, a blocked page or other error message may be accessed by the application. If the domain associated with the received DNS request is not a blocked domain, the DNS Protection servers 110 can return the DNS record for the DNS request (e.g., which may involve contacting one or more other DNS servers). Thus, the domain may be accessed by the application 120. In this manner, DNS resolution for the applications 120 of the system 102 is handled through the DNS Protection agent 112 and DNS Protection servers 110 and DNS Leak Protection is implemented such that no DNS requests may be sent from system 102 except by the DNS Protection agent 112.

Recently however, new security protocols are being utilized for such DNS requests, including DNS over HTTPS (DoH) and DNS over TLS (DoT). DoH is a protocol for performing DNS resolution via the HTTPS protocol. One goal of this method is to increase user privacy and security by preventing eavesdropping and redirection by using the HTTPS protocol to encrypt the data between the application and the DoH-based DNS resolver. DoH is basically a secure sockets layer (SSL) connection back to a DNS resolver. DoT is similarly a standard for encrypting DNS queries, differing in the methods used for encryption and delivery. DoT is a network security protocol for encrypting and wrapping DNS queries and answers via the Transport Layer Security (TLS) protocol. These security protocols for DNS may utilize different ports, such as port 443 for DoH or port 853 for DoT. In order to implement DNS Leak Protection and ensure that DNS resolution is accomplished only through DNS Protection servers 110, DNS Protection agent 112 may monitor connections from system 102 to one or more ports utilized with such secure DNS protocols.

These security protocols present challenges with regard to maintaining visibility of and control of DNS requests. For example, connections to port 443 cannot simply be blocked, without affecting conventional secure traffic to port 443, such as with banking websites or other HTTPS traffic. Because there may be no visibility to contents of HTTPS traffic, it may be desired to control whether that connection occurs at all. With respect to DoT, which generally uses a dedicated port (e.g., port 853), connections to port 853 may be blocked, for example, via a local firewall, driver, packet inspections, etc., as one skilled in the art would understand.

The DNS Protection agent 112 may monitor connections to port 443 of system 102. Protection agent 112 may also maintain a list of unauthorized destinations for these secure DNS protocols. For example, protection agent 112 may include a DNS resolver database 164 that identifies DNS resolvers to which DNS requests are to be blocked. Such a DNS resolver database may be installed at the time of installation of DNS Protection agent 112, or may be data from BrightCloud® web classification or web reputation services and may be regularly obtained or updated, for example through communication with DNS Protection servers 110 (or another service) if needed (e.g., when new DNS resolvers are determined or are retired, the agent 112 is updated for new DNS security protocols, etc.). DNS resolvers may be identified in various ways in DNS resolver database 164, such as by IP address, name, or other identifiers or combinations thereof.

Thus, the DNS Protection agent 112 may compare the destinations associated with monitored communications to the monitored ports (e.g., port 443) with known DNS resolvers in the DNS resolver database 164 and block requests to DNS resolvers. In one embodiment, DNS resolvers are identified by Internet address. If an address of a communication to a monitored port is in the database of known DNS resolvers, this communication may be blocked (e.g., using a driver or firewall on the system 102, such as the Windows firewall or the like). In this manner, DNS leaks to the monitored ports, including DNS leaks resulting from an application's use of a secure DNS protocol, or the DNS service's use of these secure DNS protocols, over the monitored ports may be prevented.

Thus, if application 120 makes a secure protocol request (e.g., via an SSL request (port 443 TCP)) to a DNS resolver 140 identified in DNS resolver database 164, the system described above will block the connection. Similarly, if the operating system 104 makes a secure protocol request to a known DNS resolver 140, the system described above will block the connection.

There may be any number of secure DNS resolvers, however, that are unknown to DNS Protection servers 110 and DNS Protection agent 112. DNS Protection agent 112 may fail to block a DNS request to an unknown secure DNS resolver not in DNS resolver database 164. To prevent or reduce this problem without blocking all requests on a relevant secure protocol port, DNS Protection agent 112 may implement processes to determine if a destination includes a secure DNS resolver.

If the destination of a communication to a monitored port is not that of a known DNS resolver, DNS Protection agent 112 probes the destination to determine if the target is a secure DNS resolver. According to one embodiment, if the destination Internet address (e.g., IP address) of a communication to a monitored port is not that of a known DNS resolver, DNS Protection agent 112 probes the destination. Probing the destination may include, in some embodiments, probing the Internet address or probing a domain associated with the Internet address to determine if the destination is a secure DNS resolver. In some cases, the DNS query uses the raw Internet address of the destination to probe (i.e., without specifying a domain name for a potential secure DNS resolver). In other cases, the DNS query may include the domain associated with an Internet address.

According to one embodiment, if the destination Internet address of a communication to a monitored port is not that of a known DNS resolver, DNS Protection agent 112 determines the domain associated with the destination address of the communication. For example, in one embodiment, DNS Protection agent 112 performs a reverse DNS lookup on the destination Internet address of the communication intercepted to the monitored port to determine the domain associated with the Internet address. Typically, application 120 will have resolved the name of the destination secure protocol server to Internet address via DNS Protection agent 112 and DNS Protection agent 112 can perform the reverse name lookup from DNS cache 162. A given Internet address may reverse lookup to multiple names in DNS cache 162. In one embodiment, DNS Protection agent 112 uses the most recent name (the name in the most recent DNS record that includes the IP address) as previous names would have already been probed when application 120 or operating system 104 made prior requests to the Internet address.

Thus, using the example of a DoH query, DNS Protection agent 112 establishes a secure connection with the destination secure protocol server and send a secure DNS request, such as:
https://<domain>/dns-query?name=

where <domain> is the domain determined from the reverse name lookup. If DNS Protection agent 112 does not have a record for the Internet address, DNS Protection agent 112 may formulate the HTTPS query using the raw Internet address, such as:
https://<IPAddress>/dns-query?name=

where <IPAddress> is the destination IP address from the intercepted communication.

DNS Protection agent 112 sends the secure DNS request from system 102 to the destination Internet address and, if known, the domain associated with the destination address (e.g., from the reverse name lookup).

If DNS Protection agent 112 receives a DNS response (i.e., a response indicating that the destination is a DNS resolver), DNS Protection agent identifies the destination address as that of a secure DNS resolver, updates DNS resolver database 164 (e.g., adds the Internet address as that of a DNS resolver), and blocks the request by application 120 or operating system 104. Examples of secure DNS responses include, for example, an HTTPS response with response code 200 (OK), possible with a DNS format error indication (FORMERR). If DNS Protection agent 112 receives a response that indicates that the destination is not a secure DNS resolver, DNS Protection agent 112 does not block the request by application 120 or operating system 104.

In addition or in the alternative to using Internet addresses to identify DNS resolvers in DNS resolver database 164, some embodiments may use other identifiers such as domain names. As mentioned, in some cases, an Internet address may be associated with multiple domain names. In some embodiments, DNS resolver database 164 may further identify DNS resolvers by domain name. Thus, rather than blocking a request to an Internet address that is associated with multiple domains based on the Internet address, DNS Protection agent 112 may perform the reverse name lookup and determine if the associated domain is that of known DNS resolver. If the associated domain name is that of a known DNS resolver, DNS Protection agent 112 may block the request. Otherwise, DNS Protection agent 112 can probe the domain.

In some embodiments, if DNS Protection agent 112 receives a response that indicates that the destination is not a secure DNS resolver, DNS Protection agent updates a database 166 of probed destinations 166 to indicate that the raw Internet address or domain has been probed and has not been determined to be a DNS resolver. This can reduce duplicative probing of the same Internet address or domain. For example, if the destination Internet address of an intercepted communication is not listed as that of a DNS resolver in DNS resolver database 164, but the domain associated with the Internet address from the reverse name lookup appears in database 166 of previously probed destination, DNS Protection agent 112 may allow access to the domain without probing the domain again. Similarly, in one embodiment, if the destination Internet address of an intercepted communication is not listed as that of a DNS resolver in DNS resolver database 164, the Internet address does not result in a domain from the reverse name lookup, and the Internet address appears in database 166 of previously probed destinations, DNS Protection agent 112 may allow access to the domain without probing the raw Internet address again.

Further, some embodiments of DNS Protection agent 112 may include an allowlist (e.g., of IP addresses or domains). If the target of a communication to a monitored port is in the allowlist, DNS Protection agent 112 allows the requester to access the destination.

DNS Protection agent 112 may distribute the identity of a DNS resolver to DNS Protection servers 110 for further analysis or to other client devices, directly or via DNS Protection servers 110, to enable the other client devices to block requests to the DNS resolver.

One example embodiment of operation will now be described with reference to FIG. 1 in which application 120 makes a secure protocol request to Internet resource server 170. DNS Protection agent 112 receives an initial DNS request on port 53 from application 120 or operating system 104, to resolve a domain name “example1.com”. As discussed above, DNS Protection agent 112 may resolve the domain name using records from DNS cache 162 or by sending a request to DNS Protection servers 110 to resolve the request. If DNS Protection servers 110 resolves the domain name, DNS Protection agent 112 caches, in DNS cache 162, a DNS record that associates the domain with an Internet address. DNS Protection agent 112 returns the Internet address for the domain to the requester. For the sake of example, it is assumed that the Internet address corresponds to Internet resource server 170.

DNS Protection agent 112 may then intercept a secure protocol request 168 to that Internet address on a monitored port (e.g., port 443). DNS Protection server 112 determines that the Internet address of Internet resource server 170 is not associated with a DNS resolver in DNS resolver database 164. DNS Protection agent 112 thus probes the Internet resource server 170 to determine if the domain “example1.com” is a secure DNS resolver. To probe the domain, DNS Protection agent determines from DNS cache 162 that the destination domain associated with the Internet address is “example1.com”, establishes a connection with Internet resource server 170 and probes the domain by sending a secure DNS request to the domain at the Internet address (e.g., https://example1.com/dns-query?name=). If DNS Protection agent 112 receives a DNS response, DNS Protection agent 112 identifies “example1.com” as a secure DNS resolver, blocks the request from application 120 or operating system 104 and adds the Internet address associated with “example1.com” to DNS resolver database 164, thus causing subsequent requests to the Internet address and, hence, associated domain “example1.com” to be blocked.

DNS Protection agent 112 may distribute the identity (e.g., Internet address) of the newly discovered DNS resolver “example1.com” to DNS Protection servers 110 or other client devices, directly or via DNS Protection servers 110, to enable the other client devices to block requests to the secure DNS resolver.

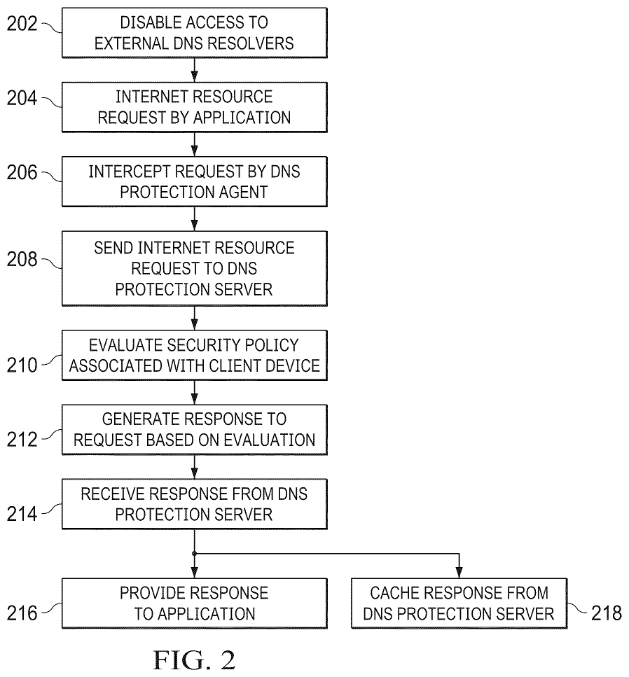

FIG. 2 is a flowchart illustrating an example of a process for DNS resolution, using the techniques described above. This example will be described in the context of an application running on a client device requesting a resource from an IP address. Embodiments of FIG. 2 may be embodied as software instructions on a non-transitory computer readable medium that are executable to perform the method of FIG. 2. In even more particular embodiments, some steps may be embodied as agent code executable to provide an agent (e.g., DNS Protection agent 112) on a client-device that performs steps 202-208 and 214-218 of FIG. 2 and code executable to provide a server (e.g., DNS Protection servers 110) that performs steps 210-212.

As mentioned above, in a conventional system, the operating system, process, or the application itself may contact an external DNS resolver. To prevent DNS leaks and increase security, access to external DNS resolvers is disabled for the application and the operating system (step 202). This may be done by inspecting traffic for DNS requests or blocking communication to remote port 53 TCP and UDP and remote port 853 TCP. Further DNS requests made by the DNS Protection agent are monitored for their requested domains and Internet addresses. Further, port 443 TCP is monitored to identify and block requests to DoH resolvers.

When the application makes a request for a resource that requires DNS resolution (step 204), the request is intercepted by a DNS Protection agent (step 206). The DNS Protection agent will handle DNS resolution for the client device using a trusted DNS Protection server. The DNS Protection agent sends the request to the DNS Protection server (step 208) to resolve the Internet address of the requested resource.

The DNS Protection server will receive the DNS request from the DNS Protection agent and make a determination as to how to handle the DNS request. In some embodiments, the DNS Protection server has access to a database(s) of domain data and system policy data. The DNS Protection server evaluates the request with respect to domain data and/or security policy data to make the determination (step 210). For example, if the domain associated with the received DNS request is not a blocked domain, the DNS Protection server can return the DNS record for the DNS request, which could involve contacting one or more other DNS servers or a cache, for example. However, if the domain associated with the DNS request is blocked, the DNS Protection server may return the address of a blocked page notification or another block or error indication. The determination whether a domain is blocked may be made with reference to domain data and system policy data associated with the requesting client device, as described above. The determination may be made in other manners as well, as one skilled in the art would understand.

At step 212 a response is generated by the DNS Protection server, based on the determination described above. At step 214, the DNS Protection agent receives the response from the DNS Protection server, provides the response to the application (step 216) and caches a record of the association between the domain name and Internet address. As a result, DNS resolution is accomplished, while maintaining visibility (by the system) of DNS activity and preventing DNS leaks (described above). The DNS Protection agent also caches the association between the Internet address and domain name (step 218). For example, the DNS Protection agent, according to one embodiment, stores the DNS record returned by the DNS Protection server in a DNS cache.

FIG. 2 is merely illustrative of one embodiment. Steps may be performed in different orders, steps omitted, or additional or alternative steps performed.

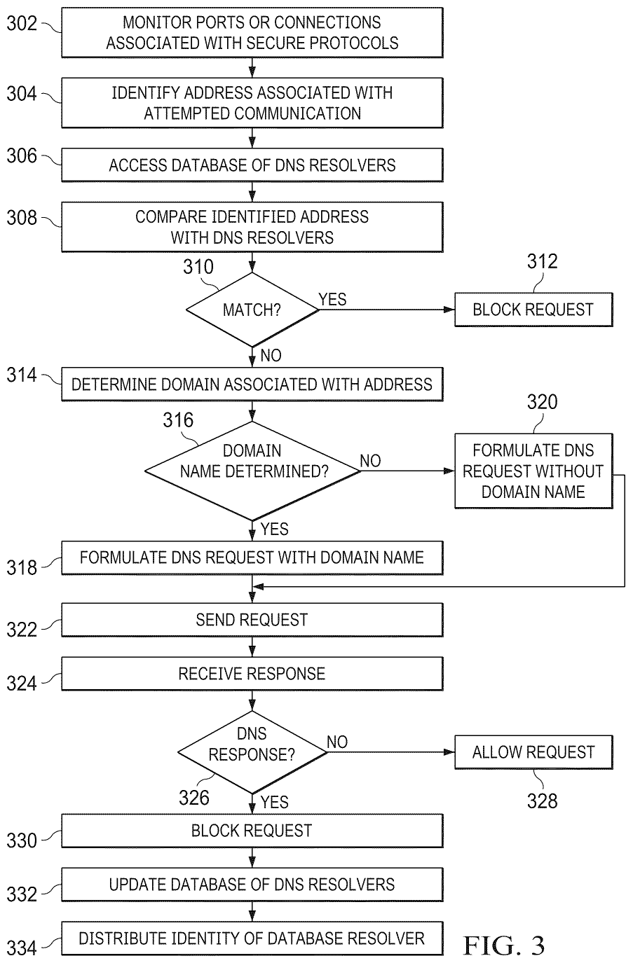

As described above, in some situations, encrypted security protocols are utilized for such DNS requests, including DoH and DoT. In order to implement DNS Leak Protection and ensure that DNS resolution is accomplished only through the DNS Protection server, the DNS Protection agent can monitor and block connections to known DNS resolvers. FIG. 3 is a flowchart illustrating an example of a process for DNS resolver identification. This example will be described in the context of an application running on a client device requesting a resource from an IP address. Embodiments of FIG. 3 may be embodied as software instructions on a non-transitory computer readable medium that are executable to perform the method of FIG. 3. In even more particular embodiments, embodiments may be embodied as agent code executable to provide an agent (e.g., DNS Protection agent 112) on a client-device that performs the steps of FIG. 3.

Initially, the DNS Protection agent gets a list of known external secure DNS resolvers and disables access to known external DNS resolvers by blocking connections to the addresses. This can be done, for example, by configuring a firewall.

At step 302, the DNS Protection agent monitors a remote port associated with secure DNS requests, such as port 443, to detect when a local application or other process is potentially making a secure DNS request. If the DNS Protection agent detects attempted communications to the monitored port, it identifies the associated Internet address for the requested Internet resource (step 304). For example, the DNS Protection agent extracts the destination IP address from an IP packet carrying the request.

As described above, the DNS Protection agent maintains a list of unauthorized destinations. For example, the DNS Protection agent maintains a DNS resolver database of known DNS resolvers for these secure DNS protocols (e.g., the IP addresses of such DNS resolvers). The DNS Protection agent accesses the DNS resolver database (step 308) and compares (step 308) the identified Internet address associated with the attempted communication with the addresses of the known DNS resolvers in the DNS resolver database. If the identified address is an unauthorized address (e.g., as determined at step 310)—for example, if the identified address is that of a DNS resolver in the DNS resolver database—the DNS Protection agent blocks the attempted communication (step 312). In this manner, DNS leaks, including DNS leaks resulting from an application's use of a secure DNS protocol, or the DNS service's use of these secure DNS protocols is prevented. This forces the client device to use the DNS Protection agent for successful DNS resolution, thus maintaining visibility of DNS activity and preventing DNS leaks.

If the identified Internet address does not match a DNS resolver, the DNS Protection agent determines the domain associated with the Internet address (step 314). For example, in one embodiment, the DNS Protection agent performs a reverse DNS lookup on the destination Internet address of the request detected to the monitored port to determine the domain associated with the Internet address. Typically, the application making the secure protocol request will have resolved the name of the secure protocol server to Internet address via DNS Protection agent and DNS Protection agent can perform the reverse name lookup from the DNS cache. A given Internet address may reverse lookup to multiple names in the DNS cache. In one embodiment, the DNS Protection agent uses the most recent domain for the Internet address (e.g., as determined from the records in the DNS cache).

If a domain is determined for the Internet address (as determined at step 316), the DNS Protection agent formulates a secure DNS request (e.g., a DoH request) using the domain name for the domain at the Internet address (step 318). If the domain cannot be determined for the identified address, the DNS Protection agent formulates a secure DNS request (e.g., a DoH request) using the raw Internet address (i.e., without including a domain at the address) (step 320).

The DNS Protection agent establishes a secure connection with the destination secure protocol server and sends the secure DNS request to the identified address (step 322). The DNS Protection agent receives a response to the secure DNS request (step 324). If the response to the secure DNS request is not a DNS response, DNS Protection agent allows the request detected at step 302 to proceed—that is, allows the application to access the destination Internet address or domain (step 328).

If the response to the secure DNS request is a DNS response, the DNS Protection agent identifies the target as a DNS resolver and blocks request detected at step 302 (step 330). The DNS Protection agent further updates the list of unauthorized destinations. For example, the DNS Protection agent updates a database of DNS resolvers with the identified Internet address (step 332). Thus, the DNS Protection agent will block subsequent secure protocol requests to the newly identified secure DNS resolver (e.g., at steps 308-312 when processing the subsequent requests).

The DNS Protection agent distributes the identity of the newly identified DNS resolver to the DNS Protection servers 110 for further analysis or other client devices, directly or via the DNS Protection server, to enable the other client devices to block requests to the secure DNS resolver.

FIG. 3 is merely illustrative of one embodiment. Steps may be performed in different orders, steps omitted, or additional or alternative steps performed.

While embodiments herein have been discussed primarily with respect to DoH DNS resolvers, it will be appreciated that embodiments are not so limited and can be applied to other protocols.

Although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention. For example, it will be understood that while embodiments as discussed herein are presented in the context of a browser-based application other embodiments may be applied with equal efficacy to other types of components on computing devices (e.g., other native components, etc.).

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such a computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the otherwise (i.e., that the reference “a” or “an” clearly indicates only the singular or only the plural).

What is claimed is:

1. A computer-implemented method for identifying domain name service (DNS) resolvers, the method comprising:
detecting, at a client device, a request from an application to a destination;
probing the destination;
identifying the destination as a DNS resolver based on a result of the probing;
based on identifying the destination as the DNS resolver, blocking, at the client device, connections to the destination.

2. The computer-implemented method of claim 1, further comprising:
identifying an Internet address for the destination, wherein probing the destination comprises:
sending a DNS request from the client device to the Internet address; and
receiving at the client device a DNS response from the destination, wherein the destination is identified as the DNS resolver based on receiving the DNS response from the destination.

3. The computer-implemented method of claim 1, further comprising:
identifying an Internet address for the destination;
determining a domain associated with the Internet address, wherein probing the destination comprises:
sending a DNS request from the client device to the domain associated with the Internet address;
receiving, at the client device, a DNS response from the domain, wherein the destination is identified as the DNS resolver based on receiving the DNS response from the domain.

4. The computer-implemented method of claim 3, further comprising:
receiving an initial DNS request from the application, the initial DNS request associated with the domain;
resolving the initial DNS request to return the Internet address to the application; and
caching, on the client device, a DNS record that associates the domain with the Internet address, wherein determining the domain associated with the Internet address comprises accessing the DNS record.

5. The computer-implemented method of claim 1, further comprising blocking subsequent requests to the DNS resolver.

6. The computer-implemented method of claim 1, further comprising:
maintaining, at the client device, a list of unauthorized destinations;
determining that the destination of the request is not blocked according to the list of unauthorized destinations.

7. The computer-implemented method of claim 6, further comprising:
adding the DNS resolver to the list of unauthorized destinations based on identifying the destination of the request as the DNS resolver.

8. The computer-implemented method of claim 1, further comprising distributing an identifier for the DNS resolver to other client devices to enable the other client devices to block requests to the DNS resolver.

9. A computer program product comprising a non-transitory, computer-readable medium storing instructions executable for:
detecting, at a client device, a request from an application to a destination;
probing the destination;
identifying the destination as a DNS resolver based on result of the probing;
based on identifying the destination as the DNS resolver, blocking, at the client device, the request from the application to the destination.

10. The computer program product of claim 9, further comprising instructions executable for identifying an Internet address from the request, wherein probing the destination comprises:
sending a DNS request from the client device to the Internet address; and
receiving at the client device a DNS response from the destination, wherein the destination is identified as the DNS resolver based on receiving the DNS response from the destination.

11. The computer program product of claim 9, further comprising instructions executable for:
identifying an Internet address for the request; and
determining a domain associated with the Internet address, wherein probing the destination comprises:
sending a DNS request from the client device to the domain associated with the Internet address;
receiving at the client device a DNS response from the domain, wherein the destination is identified as the DNS resolver based on receiving the DNS response from the domain.

12. The computer program product of claim 11, further comprising instructions executable for:
receiving an initial DNS request from the application, the initial DNS request associated with the domain;
resolving the initial DNS request to return the Internet address to the application; and
caching, on the client device, a DNS record that associates the domain with the Internet address, wherein determining the domain associated with the Internet address comprises accessing the DNS record.

13. The computer program product of claim 9, further comprising instructions executable for blocking subsequent requests to the DNS resolver.

14. The computer program product of claim 9, further comprising instructions executable for:
maintaining, at the client device, a list of unauthorized destinations;
blocking requests from the client device to the unauthorized destinations specified in the list of unauthorized destinations; and
determining that the destination of the request is not blocked according to the list of unauthorized destinations, wherein the destination is probed based on a determination that the destination is not blocked.

15. The computer program product of claim 14, further comprising instructions executable for:
adding the DNS resolver to the list of unauthorized destinations based on identifying the destination as the DNS resolver.

16. The computer program product of claim 9, further comprising instructions executable for distributing an identifier for the DNS resolver to other client devices to enable the other client devices to block requests to the DNS resolver.

17. A system for identifying DNS resolvers:
a processor;
a computer memory in electronic communication with the processor, the computer memory storing agent code executable to provide an agent on a client device, the agent code executable for:
detecting, at the client device, a request from an application to a destination;
probing the destination;
identifying the destination as a DNS resolver based on a result of the probing;
based on identifying the destination as the DNS resolver, blocking, at the client device, the request from the application to the destination.

18. The system of claim 17, wherein the agent code further comprises instructions for: after identifying the destination as the DNS resolver, blocking subsequent requests to the destination.

19. The system of claim 17, wherein the agent code further comprises instructions for:
identifying an Internet address from the request;
determining a domain associated with the Internet address, wherein probing the destination comprises:
sending a DNS request from the client device to the domain associated with the Internet address;
receiving at the client device a DNS response from the domain, wherein the destination is identified as the DNS resolver based on receiving the DNS response from the domain.

20. The system of claim 19, wherein the agent code further comprises instructions for:
receiving an initial DNS request from the application, the initial DNS request associated with the domain;
resolving the initial DNS request to return the Internet address to the application; and
caching, on the client device, a DNS record that associates the domain with the Internet address, wherein determining the domain associated with the Internet address comprises accessing the DNS record.

21. The system of claim 19, wherein the agent code further comprises instructions for:
maintaining, at the client device, a list of unauthorized destinations;
blocking, by the agent at the client device, requests from the client device to the unauthorized destinations specified in the list of unauthorized destinations;
determining that the destination of the request is not blocked according to the list of unauthorized destinations, wherein the destination is probed based on a determination that the domain is not blocked.

22. The system of claim 21, wherein the agent code further comprises instructions for:
adding the DNS resolver to the list of unauthorized destinations.
